(19) United States
(12) Patent Application Publication
(10) Pub. No.: US 2026/0073644 A1
(43) Pub. Date: Mar. 12, 2026

(54) MOTION MATCHING DEVICE AND METHOD FOR HETEROGENEOUS 3D MODELS

(71) Applicant: KOREA ELECTRONICS TECHNOLOGY INSTITUTE, Seongnam-si (KR)

(72) Inventors: Jin Young LEE, Seoul (KR); Sang Shin LEE, Yongin-si (KR); Won Gi CHOI, Seoul (KR); Ju Kyung YOO, Seoul (KR); Ankhzaya BAATARBILEG, Suwon-si (KR); Yeonu JUNG, Suwon-si (KR)

(21) Appl. No.: 18/924,251

(22) Filed: Oct. 23, 2024

(30) Foreign Application Priority Data
Sep. 6, 2024 (KR) 10-2024-0121363

(51) Int. Cl. G06T 19/00; G06T 7/73

(52) U.S. Cl. CPC G06T 19/006; G06T 7/75; G06T 2207/10016; G06T 2210/32

(57) ABSTRACT

Proposed is a motion matching method. The method may include collecting real-time images taken in real time and non-real-time images taken previously and acquiring real-time motion data on a first object contained in the real-time images and non-real-time motion data on a second object contained in the non-real-time images. The method may also include operating a real-time 3D model by applying the real-time motion data to the real-time 3D model and operating a non-real-time 3D model by applying the non-real-time motion data to the non-real-time 3D model, and setting a start point by finding a pose of the non-real-time 3D model that matches a pose of the real-time 3D model. The method may further include matching motions of the real-time 3D model and the non-real-time 3D model by operating the real-time and non-real-time 3D models based on the start point.

### CROSS-REFERENCE TO RELATED APPLICATION

This application claims priority to Korean Patent Application No. 10-2024-0121363 filed on Sep. 6, 2024, the entirety of which is incorporated herein by reference for all purposes.

### STATEMENT REGARDING GOVERNMENT SPONSORED RESEARCH OR DEVELOPMENT

This research was supported by “Cultural Technology Research and Development: Development of a multi-purpose broadcast studio platform to support multi-user interaction and virtual being” through the Korea Creative Content Agency funded by the Ministry of Culture, Sports and Tourism (Project Number: 1375027587).

### BACKGROUND

### Technical Field

The present disclosure relates to a device and method for motion matching of heterogeneous 3D models. In particular, the present disclosure relates to a device and method for motion matching between a real-time 3D model and a non-real-time 3D model based on a pose of the real-time 3D model.

### Description of Related Technology

As the metaverse market grows, the demand for its core element, 3D image generation technology, is also rapidly increasing. The metaverse can be defined as a three-dimensional (3D) virtual world (or virtual space) where social and economic activities similar to those in the real world take place.

### SUMMARY

One aspect is a motion matching device and method for heterogeneous 3D models that matches motions between a real-time 3D model and a non-real-time 3D model.

Another aspect is a method for motion matching of heterogeneous three-dimensional (3D) models performed by a motion matching device and including collecting real-time images taken in real time and non-real-time images taken previously; acquiring real-time motion data on a first object contained in the real-time images and non-real-time motion data on a second object contained in the non-real-time images; operating a real-time 3D model by applying the real-time motion data to the real-time 3D model and operating a non-real-time 3D model by applying the non-real-time motion data to the non-real-time 3D model; setting a start point by finding a pose of the non-real-time 3D model that matches a pose of the real-time 3D model; and matching motions of the real-time 3D model and the non-real-time 3D model by operating the real-time 3D model and the non-real-time 3D model based on the start point.

In the method, the real-time images may be real-time streaming images taken with a stereo camera, and the non-real-time images may be a previously taken video.

In the method, upon acquiring the real-time motion data, the motion matching device may acquire real-time motion capture data by performing a real-time motion capture for the first object contained in the real-time streaming images; and acquire the real-time motion data by converting the real-time motion capture data into a BVH (BioVision hierarchical data) format.

In the method, upon acquiring the non-real-time motion data, the motion matching device may convert a camera coordinate system of the previously taken video from a local coordinate system to a world coordinate system; acquire non-real-time motion capture data by performing a non-real-time motion capture for the second object contained in the previously taken video in the world coordinate system; and acquire the non-real-time motion data by converting the non-real-time motion capture data into a BVH format.

In the method, upon acquiring the non-real-time motion capture data, the motion matching device may perform the non-real-time motion capture through pose estimation for the second object contained in the previously taken video.

In the method, upon setting the start point, the motion matching device may set the start point by finding the non-real-time motion data that matches the real-time motion data corresponding to a pose of the real-time 3D model.

In the method, upon setting the start point, the motion matching device may find a pose of the non-real-time 3D model that matches a specific pose within a given time from a time point at which the real-time 3D model starts motion.

In the method, upon setting the start point, the motion matching device may extract a reference pose from motions of the real-time 3D model within the given time; extract a matching pose that matches the reference pose from motions of the non-real-time 3D model; and set, as the start point, a time point when the reference pose of the real-time 3D model and the matching pose of the non-real-time 3D model are taken.

In the method, upon extracting the matching pose, in order to correct a deviation caused by a size difference between the real-time 3D model and the non-real-time 3D model, the motion matching device may correct a vector of the reference pose with a correction value according to the size difference between the real-time 3D model and the non-real-time 3D model, and then extract a vector of the matching pose that matches the corrected vector of the reference pose.

Another aspect is a motion matching device of heterogeneous three-dimensional (3D) models that includes an image collecting unit that collects real-time images taken in real time and non-real-time images taken previously; a motion data acquiring unit that acquires real-time motion data on a first object contained in the real-time images and non-real-time motion data on a second object contained in the non-real-time images; a 3D model operating unit that operates a real-time 3D model by applying the real-time motion data to the real-time 3D model and operates a non-real-time 3D model by applying the non-real-time motion data to the non-real-time 3D model; a start point setting unit that sets a start point by finding a pose of the non-real-time 3D model that matches a pose of the real-time 3D model; and a motion matching unit that matches motions of the real-time 3D model and the non-real-time 3D model by operating the real-time 3D model and the non-real-time 3D model based on the start point.

Another aspect is a motion matching system of heterogeneous three-dimensional (3D) models is provided. The system may include a real-time image providing device that provides real-time images taken in real time; a non-real-time image providing device that provides non-real-time images that have already been taken; and the motion matching device that matches motions of a real-time 3D model operating based on the real-time images and a non-real-time 3D model operating based on the non-real-time images, and expresses the matched motions in a virtual world.

According to the present disclosure, it is possible to match motions between the real-time 3D model and the non-real-time 3D model based on a pose of the real-time 3D model. That is, by finding a pose of the non-real-time 3D model that matches a specific pose of the real-time 3D model and interworking the real-time 3D model and the non-real-time 3D model with the specific pose as a start point, the motion of the non-real-time 3D model can be matched based on the motion of the real-time 3D model. Accordingly, it is possible to realize natural collaborative motions between the real-time 3D model and the non-real-time 3D model in a virtual world.

According to the present disclosure, in order to correct a deviation caused by a size difference between the real-time 3D model and the non-real-time 3D model, the motion matching device can correct a vector of a reference pose with a correction value according to the size difference between the real-time 3D model and the non-real-time 3D model, and then extract a vector of a matching pose that matches the corrected vector of the reference pose, thereby performing motion matching between the real-time 3D model and the non-real-time 3D model more accurately.

Through such motion matching between the real-time 3D model and the non-real-time 3D model, the real-time nature of content creation can be improved. In other words, the real-time 3D model and the non-real-time 3D model can be made to operate in a virtual world harmoniously without a sense of incongruity.

### BRIEF DESCRIPTION OF THE DRAWINGS

FIG. 1 is a block diagram showing a motion matching system for heterogeneous 3D models according to an embodiment of the present disclosure.

FIG. 2 is a block diagram showing a motion matching device of FIG. 1.

FIG. 3 is a flowchart showing a motion matching method for heterogeneous 3D models according to an embodiment of the present disclosure.

FIG. 4 is a detailed flowchart showing a step of acquiring real-time motion data of FIG. 3.

FIG. 5 is a detailed flowchart showing a step of acquiring non-real-time motion data of FIG. 3.

FIG. 6 is a detailed flowchart showing a step of setting a start point of FIG. 3.

FIG. 7 is an exemplary screenshot showing motion matching of a real-time 3D model and a non-real-time 3D model according to an embodiment of the present disclosure.

### DETAILED DESCRIPTION

In order to realize the metaverse, interest in 3D imaging technology that converts the real world into 3D and expresses it in the virtual world is also increasing significantly. Existing 3D imaging technology has been mainly used in the gaming field, but recently, there is a trend of expanding its application to all industrial fields. For example, 3D imaging technology is expanding its scope of application to various content industries such as AR/VR, movies, animation, and broadcasting.

Virtual objects that make up the virtual world are embodied and expressed as 3D models by utilizing 3D imaging technology for real objects. These 3D models can be implemented through motion capture based on real-time taken images (hereinafter referred to as “real-time motion capture”) or through motion capture based on already taken images (hereinafter referred to as “non-real-time motion capture”).

That is, the 3D models include a real-time 3D model that applies real-time motion capture data for a first object, and a non-real-time 3D model that applies non-real-time motion capture data for a second object. In order to create content using the real-time 3D model and the non-real-time 3D model in a virtual world, it is necessary to match the motions between the real-time 3D model and the non-real-time 3D model.

Now, embodiments of the present disclosure will be described in detail with reference to the accompanying drawings. However, in the following description and the accompanying drawings, well known techniques may not be described or illustrated in detail to avoid obscuring the subject matter of the present disclosure. Through the drawings, the same or similar reference numerals denote corresponding features consistently.

The terms and words used in the following description, drawings and claims are not limited to the bibliographical meanings thereof and are merely used by the inventor to enable a clear and consistent understanding of the disclosure. Thus, it will be apparent to those skilled in the art that the following description about various embodiments of the present disclosure is provided for illustration purpose only and not for the purpose of limiting the disclosure as defined by the appended claims and their equivalents.

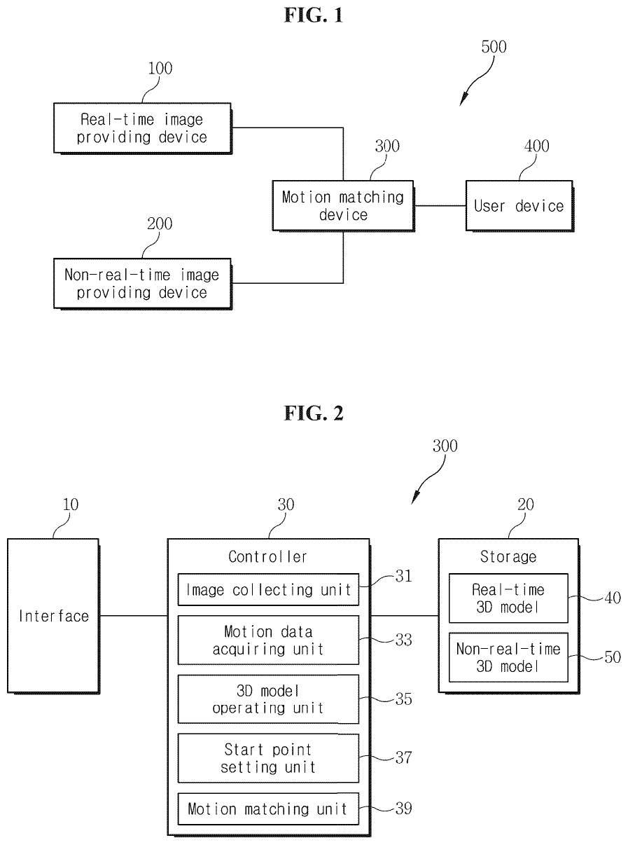

FIG. 1 is a block diagram showing a motion matching system for heterogeneous 3D models according to an embodiment of the present disclosure.

Referring to FIG. 1, the motion matching system 500 for heterogeneous 3D models according to the embodiment is a system that matches motions between a real-time 3D model and a non-real-time 3D model based on a pose of the real-time 3D model. That is, in the embodiment, the heterogeneous 3D models include the real-time 3D model and the non-real-time 3D model.

The motion matching system 500 includes a real-time image providing device 100, a non-real-time image providing device 200, and a motion matching device 300. The real-time image providing device 100 provides real-time images taken in real time. The non-real-time image providing device 200 provides non-real-time images that have already been taken. The motion matching device 300 matches the motions of the real-time 3D model operating based on real-time images and the non-real-time 3D model operating based on non-real-time images, and expresses them in a virtual world.

In addition, the motion matching system 500 may further include a user device 400.

The real-time 3D model is defined as a 3D model that expresses a first object contained in a real-time image to a virtual world. To express the first object, the real-time 3D model imitates the motion of the first object. The first object is an object capable of performing motion, including a person, and may include, but is not limited to, animals, robots, characters, avatars, etc.

The non-real-time 3D object is defined as a 3D model that expresses a second object contained in a non-real-time image to a virtual world. To express the second object, the non-real-time 3D model imitates the motion of the second object. The second object is an object capable of performing motion, including a person, and may include, but is not limited to, animals, robots, characters, avatars, etc.

In general, the real-time 3D model and the non-real-time 3D model depend on the motions of the first and second objects, respectively. However, they perform independent motions because the first and second objects do not form a dependency relationship in their motions.

The motion matching system 500 implements a virtual world by matching the motions of the real-time 3D model and the non-real-time 3D model. That is, the motion matching system 500 uses a method of finding and matching a similar pose among the poses of the non-real-time 3D model, based on the pose of the real-time 3D model.

Hereinafter, the motion matching system 500 according to the embodiment will be described in detail.

The user device 400 is a communication terminal used by a user who uses a virtual world implemented by the motion matching device 300. Using the user device 400, the user can view the real-time 3D model and the non-real-time 3D model whose motions are matched in the virtual world provided by the motion matching device 300. The user device 400 may include, for example, a smartphone, a laptop, a handheld PC, a tablet PC, etc.

The real-time image providing device 100 photographs in real time the first object corresponding to the real-time 3D model and transmits the taken real-time image to the motion matching device 300. The real-time image providing device 100 includes a stereo camera that photographs the first object in real time. The real-time image providing device 100 transmits the real-time images of the first object taken by the stereo camera to the motion matching device 300 in real-time streaming. The real-time image providing device 100 provides the real-time images of the first object taken by the stereo camera to the motion matching device 300 in real-time streaming through a wire or a communication network. The real-time image providing device 100 may be a dedicated electronic device, a personal computer (PC), or the like which includes the stereo camera and is capable of communication.

The non-real-time image providing device 200 stores previously taken non-real-time images and provides the previously taken non-real-time images in response to a request of the motion matching device 300. The previously taken non-real-time image requested by the motion matching device 300 contains the second object to be matched to the first object. The non-real-time images include a previously taken video. The non-real-time image providing device 200 provides the non-real-time images to the motion matching device 300 via a wire or communication network. The non-real-time image providing device 200 may be a dedicated electronic device, a PC, a server, a cloud server, or the like which is capable of communication.

The real-time image of the first object is an image obtained by photographing the first object in real time and streamed. The real-time image of the first object may be an image obtained by photographing with the stereo camera the motion of the first object which knows the previously taken non-real-time image of the second object, in which the motion of the first object corresponds to the previously taken non-real-time image of the second object.

In addition, the motion matching device 300 implements a virtual world by utilizing the real-time 3D model and the non-real-time 3D model. The motion matching device 300 obtains motion data of an object contained in an image and applies the obtained motion data to a 3D model, thereby causing the 3D model of the virtual world to perform the motion of the object. That is, the motion matching device 300 applies real-time motion data to the real-time 3D model, applies non-real-time motion data to the non-real-time 3D model, and matches motions between the real-time 3D model and the non-real-time 3D model based on the pose of the real-time 3D model. The motion matching device 300 may be a dedicated device, a PC, a server, a cloud server, or the like which is capable of communicating with both the real-time image providing device 100 and the non-real-time image providing device 200.

At the request of the user device 400, the motion matching device 300 provides a virtual world including the real-time 3D model and the non-real-time 3D model with motions matched.

The motion matching device 300 according to this embodiment will be described below with reference to FIGS. 1 and 2. FIG. 2 is a block diagram showing the motion matching device 300 of FIG. 1.

The motion matching device 300 includes an interface 10, a storage 20, and a controller 30.

The interface 10 performs communication with the real-time image providing device 100, the non-real-time image providing device 200, and the user device 400. The interface 10 receives a real-time image from the real-time image providing device 100 in real-time streaming. The interface 10 receives a previously taken non-real-time image from the non-real-time image providing device 200.

The interface 10 transmits, to the user device 400, a virtual world including a real-time 3D model 40 and a non-real-time 3D model 50, whose motions are matched, under the control of the controller 30.

The storage 20 stores a program required for controlling the operation of the motion matching device 300, and information generated during the execution of the program. The storage 20 stores an execution program for matching the motions of the real-time 3D model 40 and the non-real-time 3D model 50. The storage 20 stores the real-time 3D model 40 and the non-real-time 3D model 50. The storage 20 may store real-time images provided by the real-time image providing device 100. The storage 20 may store previously taken images provided by the non-real-time image providing device 200.

The controller 30 includes at least one processor that performs the overall control operations of the motion matching device 300. The controller 30 performs the motion matching of the real-time 3D model 40 and the non-real-time 3D model 50.

Specifically, the controller 30 includes an image collecting unit (or an image collecting processor) 31, a motion data acquiring unit (or a motion data acquiring processor) 33, a 3D model operating unit (or a 3D model operating processor) 35, a start point setting unit (or a a start point setting processor) 37, and a motion matching unit (or a motion matching processor) 39. The image collecting unit 31 collects real-time images taken in real time and non-real-time images taken previously. The motion data acquiring unit 33 acquires real-time motion data on a first object contained in the real-time images and acquires non-real-time motion data on a second object contained in the non-real-time images. The 3D model operating unit 35 operates the real-time 3D model 40 by applying the real-time motion data to the real-time 3D model 40 and operates the non-real-time 3D model 50 by applying the non-real-time motion data to the non-real-time 3D model 50. The start point setting unit 37 sets a start point by finding a pose of the non-real-time 3D model 50 that matches a pose of the real-time 3D model 40. The motion matching unit 39 matches the motions of the real-time 3D model 40 and the non-real-time 3D model 50 by operating the real-time 3D model 40 and the non-real-time 3D model 50 based on the start point.

The real-time images collected by the image collecting unit 31 are real-time streaming images taken by a stereo camera, and the non-real-time images are a previously taken video. The real-time images are provided by the real-time image providing device 100. The previously taken video is provided by the non-real-time image providing device 200.

The motion data acquiring unit 33 can acquire the real-time motion data and the non-real-time motion data, as follows.

First, the motion data acquiring unit 33 acquires the real-time motion data. Specifically, the motion data acquiring unit 33 performs a real-time motion capture on a first object contained in the real-time streaming image and thereby acquires real-time motion capture data. Then, the motion data acquiring unit 33 converts the real-time motion capture data into a BVH (BioVision hierarchical data) format and thereby acquires the real-time motion data. Here, the real-time motion capture data may have a json file format.

In addition, the motion data acquiring unit 33 acquires the non-real-time motion data. Specifically, the motion data acquiring unit 33 converts the camera coordinate system of the previously taken video from the local coordinate system to the world coordinate system. Next, the motion data acquiring unit 33 performs a non-real-time motion capture on a second object contained in the previously taken video in the world coordinate system and thereby acquires non-real-time motion capture data. Then, the motion data acquiring unit 33 converts the non-real-time motion capture data into a BVH format and thereby acquires the non-real-time motion data. Here, the non-real-time motion capture data may have a json file format. The motion data acquiring unit 33 may perform the non-real-time motion capture by estimating a pose of the second object contained in the previously taken video.

The pose estimation is an image processing technology that recognizes the pose of an object using machine learning as a learning model based on artificial intelligence (AI) in the form of open source. The motion data acquiring unit 33 may be equipped with a learning model of pose estimation in the form of a library. For example, if the object is a human, the learning model for pose estimation can find joint parts (key points) from the image of the object and extract the skeleton and joint movements of the human body as digital data. In addition, the learning model of pose estimation can determine the pose of the object from the extracted digital data.

The start point setting unit 37 sets a start point that can be used to match the motions of the real-time 3D model 40 and the non-real-time 3D model 50. The start point setting unit 37 finds the non-real-time motion data matching the real-time motion data corresponding to the pose of the real-time 3D model 40 and sets it as a start point.

The start point setting unit 37 finds a pose of the non-real-time 3D model 50 that matches a specific pose within a certain time from the time point at which the real-time 3D model 40 starts motion, and sets the found pose as a start point. That is, the start point setting unit 37 finds an image frame having a pose of the non-real-time 3D model that matches a specific pose of the real-time 3D model in the non-real-time motion data of a certain time applied to the non-real-time 3D model. Here, the certain time may be set to a time within 60 seconds, preferably within 15 seconds, and more preferably within 5 seconds.

The start point is an editing point or synchronizing point that starts matching the motion of the real-time 3D model 40 and the motion of the non-real-time 3D model 50. The start point is an image frame of the BVH that starts matching for interlocking of BVH data between the real-time 3D model 40 and the non-real-time 3D model 50.

Specifically, the start point setting unit 37 may set the start point, as follows.

First, the start point setting unit 37 extracts a reference pose from the motions of the real-time 3D model 40 within a certain time. The start point setting unit 37 can extract a vector of the reference pose through pose estimation.

Then, the start point setting unit 37 extracts a matching pose that matches the reference pose from the motions of the non-real-time 3D model 50. The start point setting unit 37 can extract vectors of poses of the non-real-time 3D model 50 through pose estimation. The start point setting unit 37 can extract a pose matching the vector of the reference pose from among the vectors of the poses of the non-real-time 3D model 50 as a vector of the matching pose.

When extracting the matching pose, any undesired matching pose that does not match due to a deviation caused by a size difference between the real-time 3D model 40 and the non-real-time 3D model 50 may be extracted. Therefore, in this embodiment, in order to correct the deviation caused by the size difference between the real-time 3D model 40 and the non-real-time 3D model 50, the start point setting unit 37 corrects the vector of the reference pose with a correction value according to the size difference between the real-time 3D model 40 and the non-real-time 3D model 50, and then extracts the vector of the matching pose that matches the corrected vector of the reference pose.

In addition, the start point setting unit 37 sets, as the start point, a time point when the reference pose of the real-time 3D model 40 and the matching pose of the non-real-time 3D model 50 are taken.

Meanwhile, in this embodiment, an example of setting the start point based on the pose of the real-time 3D model 40 is used, but conversely, the start point may be set based on the pose of the non-real-time 3D model 50.

The motion matching unit 39 matches the motions of the real-time 3D model 40 and the non-real-time 3D model 50 based on the start point. Here, matching the motions means that the real-time 3D model 40 and the non-real-time 3D model 50 operate in the virtual world by synchronizing based on the start point. Since the real-time 3D model 40 and the non-real-time 3D model 50 operate independently based on real-time motion data and non-real-time motion data, respectively, the real-time 3D model 40 and the non-real-time 3D model 50 not only perform the same motion, but also include independent motions, interactive motions, etc.

The motion matching unit 39 expresses in the virtual world the real-time 3D model 40 and the non-real-time 3D model 50 whose motions are matched. At the request of the user device 400, the motion matching unit 39 may provide the user device 400 with the virtual world including the real-time 3D model 40 and the non-real-time 3D model 50 whose motions are matched.

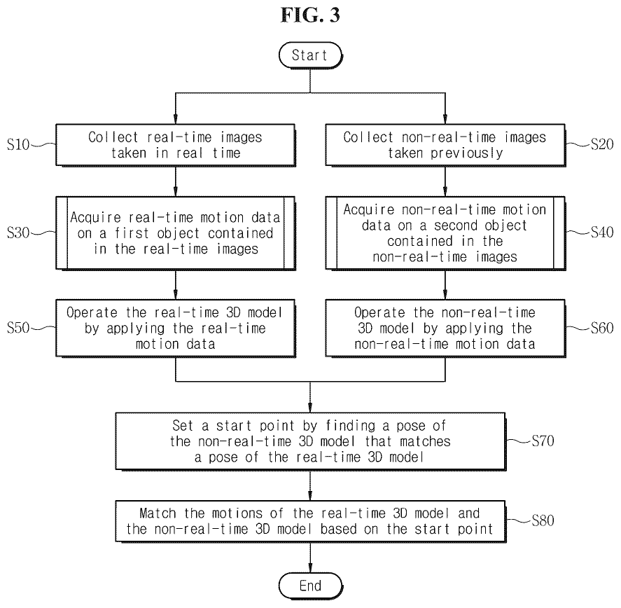

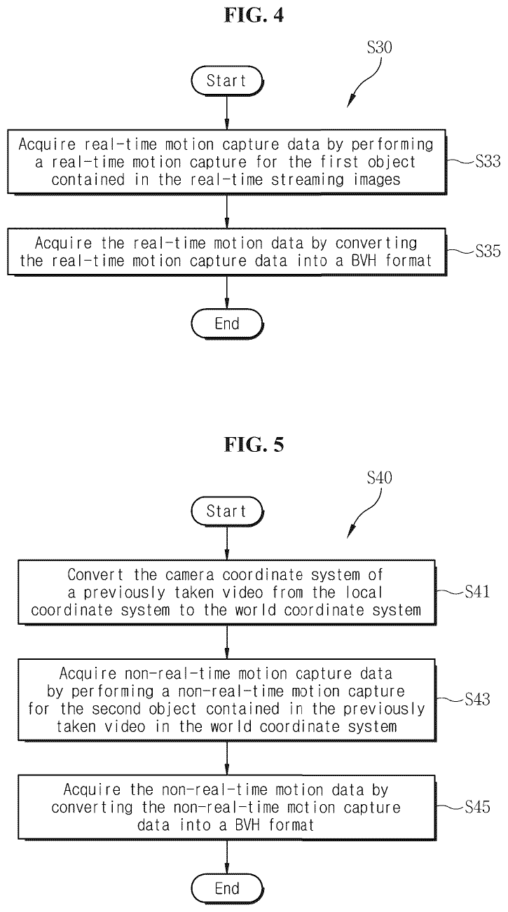

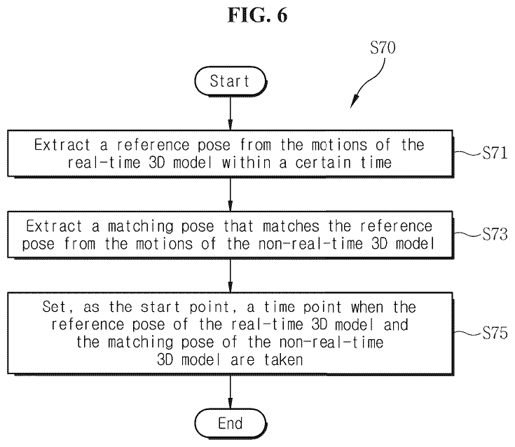

Now, the motion matching method of heterogeneous 3D models using the motion matching system 500 according to this embodiment will be described with reference to FIGS. 1 to 6. FIG. 3 is a flowchart showing a motion matching method for heterogeneous 3D models according to an embodiment of the present disclosure. FIG. 4 is a detailed flowchart showing a step of acquiring real-time motion data of FIG. 3. FIG. 5 is a detailed flowchart showing a step of acquiring non-real-time motion data of FIG. 3. FIG. 6 is a detailed flowchart showing a step of setting a start point of FIG. 3.

First, in steps S10 and S20, the motion matching device 300 collects real-time images taken in real time and non-real-time images taken previously.

Next, in steps S30 and S40, the motion matching device 300 acquires real-time motion data on a first object contained in the real-time images and non-real-time motion data on a second object contained in the non-real-time images.

Specifically, the step S30 may be performed as shown in FIG. 4.

That is, in step S33, the motion matching device 300 acquires real-time motion capture data by performing a real-time motion capture for the first object contained in the real-time streaming images.

Then, in step S35, the motion matching device 300 acquires the real-time motion data by converting the real-time motion capture data into a BVH format.

Specifically, the step S40 may be performed as shown in FIG. 5.

That is, in step S41, the motion matching device 300 converts the camera coordinate system of a previously taken video from the local coordinate system to the world coordinate system.

Then, in step S43, the motion matching device 300 acquires non-real-time motion capture data by performing a non-real-time motion capture for the second object contained in the previously taken video in the world coordinate system. At this time, the motion matching device 300 may perform the non-real-time motion capture through pose estimation for the second object contained in the previously taken video.

Then, in step S45, the motion matching device 300 acquires the non-real-time motion data by converting the non-real-time motion capture data into a BVH format.

Returning to FIG. 3, in steps S50 and S60, the motion matching device 300 operates the real-time 3D model 40 by applying the real-time motion data to the real-time 3D model 40, and operates the non-real-time 3D model 50 by applying the non-real-time motion data to the non-real-time 3D model 50.

Next, in step S70, the motion matching device 300 sets a start point by finding a pose of the non-real-time 3D model 50 that matches a pose of the real-time 3D model 40. That is, the motion matching device 300 sets the start point by finding the non-real-time motion data that matches the real-time motion data corresponding to the pose of the real-time 3D model 40.

Specifically, the step S70 may be performed as shown in FIG. 5.

That is, in step S71, the motion matching device 300 extracts a reference pose from the motions of the real-time 3D model 40 within a certain time. The motion matching device 300 may extract a vector of the reference pose through pose estimation.

Next, in step S73, the motion matching device 300 extracts a matching pose that matches the reference pose from the motions of the non-real-time 3D model 50. The motion matching device 300 may extract vectors of poses of the non-real-time 3D model 50 through pose estimation. The motion matching device 300 may extract a pose matching the vector of the reference pose from among the vectors of the poses of the non-real-time 3D model 50 as a vector of the matching pose.

When extracting the matching pose, any undesired matching pose that does not match due to a deviation caused by a size difference between the real-time 3D model 40 and the non-real-time 3D model 50 may be extracted. Therefore, in this embodiment, in order to correct the deviation caused by the size difference between the real-time 3D model 40 and the non-real-time 3D model 50, the motion matching device 300 may correct the vector of the reference pose with a correction value according to the size difference between the real-time 3D model 40 and the non-real-time 3D model 50, and then extract the vector of the matching pose that matches the corrected vector of the reference pose.

Next, in step S75, the motion matching device 300 sets, as the start point, a time point when the reference pose of the real-time 3D model 40 and the matching pose of the non-real-time 3D model 50 are taken.

Returning to FIG. 3, in step S80, the motion matching device 300 matches the motions of the real-time 3D model 40 and the non-real-time 3D model 50 by operating the real-time 3D model 40 and the non-real-time 3D model 50 based on the start point.

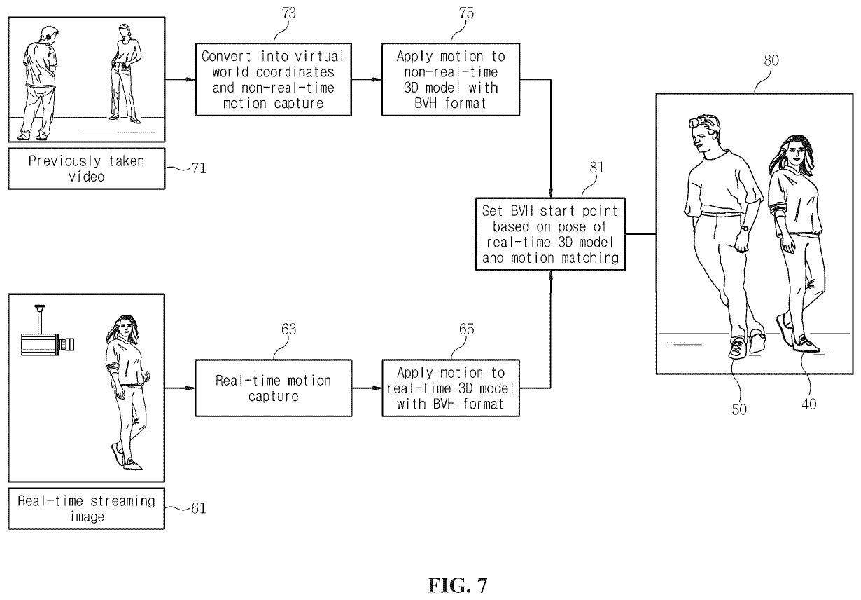

The above-described motion matching method of heterogeneous 3D models according to this embodiment will be described hereinafter with reference to FIG. 7. FIG. 7 is an exemplary screenshot showing motion matching of a real-time 3D model 40 and a non-real-time 3D model 50 according to an embodiment of the present disclosure.

The motion matching device 300 collects a real-time streaming image 61 and a previously taken video 71.

Next, in step 63, the motion matching device 300 performs a real-time motion capture for a first object in the real-time streaming image 61 containing the first object.

Next, in step 65, the motion matching device 300 converts the real-time motion capture data into a BVH format and applies it to the real-time 3D model 40.

Meanwhile, in step 73, the motion matching device 300 converts the previously taken video 71 containing a second object into virtual world coordinates and then performs a non-real-time motion capture for the second object. Converting into virtual world coordinates refers to converting the camera coordinate system of the previously taken video 71 from a local coordinate system to a world coordinate system.

Next, in step 75, the motion matching device 300 converts the non-real-time motion capture data into a BVH format and applies it to the non-real-time 3D model 50.

In addition, in step 81, the motion matching device 300 sets a BVH start point based on the pose of the real-time 3D model 40 and then matches the motions of the real-time 3D model 40 and the non-real-time 3D model 50 to express them in a virtual world 80.

While the present disclosure has been particularly shown and described with reference to an exemplary embodiment thereof, it will be understood by those skilled in the art that various changes in form and details may be made therein without departing from the scope of the present disclosure as defined by the appended claims.

What is claimed is:

1. A method for motion matching of heterogeneous three-dimensional (3D) models, performed by a motion matching device, the method comprising:
collecting real-time images taken in real time and non-real-time images taken previously;
acquiring real-time motion data on a first object contained in the real-time images and non-real-time motion data on a second object contained in the non-real-time images;
operating a real-time 3D model by applying the real-time motion data to the real-time 3D model and operating a non-real-time 3D model by applying the non-real-time motion data to the non-real-time 3D model;
setting a start point by finding a pose of the non-real-time 3D model that matches a pose of the real-time 3D model; and
matching motions of the real-time 3D model and the non-real-time 3D model by operating the real-time 3D model and the non-real-time 3D model based on the start point.

2. The method of claim 1, wherein the real-time images comprise real-time streaming images taken with a stereo camera, and the non-real-time images comprise a previously taken video.

3. The method of claim 2, wherein upon acquiring the real-time motion data, the motion matching device:
acquires real-time motion capture data by performing a real-time motion capture for the first object contained in the real-time streaming images; and
acquires the real-time motion data by converting the real-time motion capture data into a biovision hierarchical data (BVH) format.

4. The method of claim 3, wherein upon acquiring the non-real-time motion data, the motion matching device:
converts a camera coordinate system of the previously taken video from a local coordinate system to a world coordinate system;
acquires non-real-time motion capture data by performing a non-real-time motion capture for the second object contained in the previously taken video in the world coordinate system; and
acquires the non-real-time motion data by converting the non-real-time motion capture data into a BVH format.

5. The method of claim 4, wherein upon acquiring the non-real-time motion capture data, the motion matching device performs the non-real-time motion capture through pose estimation for the second object contained in the previously taken video.

6. The method of claim 1, wherein upon setting the start point, the motion matching device sets the start point by finding the non-real-time motion data that matches the real-time motion data corresponding to a pose of the real-time 3D model.

7. The method of claim 6, wherein upon setting the start point, the motion matching device finds a pose of the non-real-time 3D model that matches a specific pose within a given time from a time point at which the real-time 3D model starts motion.

8. The method of claim 7, wherein upon setting the start point, the motion matching device:
extracts a reference pose from motions of the real-time 3D model within the given time;
extracts a matching pose that matches the reference pose from motions of the non-real-time 3D model; and
sets, as the start point, a time point when the reference pose of the real-time 3D model and the matching pose of the non-real-time 3D model are taken.

9. The method of claim 8, wherein upon extracting the matching pose, in order to correct a deviation caused by a size difference between the real-time 3D model and the non-real-time 3D model, the motion matching device corrects a vector of the reference pose with a correction value according to the size difference between the real-time 3D model and the non-real-time 3D model, and then extracts a vector of the matching pose that matches the corrected vector of the reference pose.

10. A motion matching device of heterogeneous three-dimensional (3D) models, the device comprising:
an image collecting processor configured to collect real-time images taken in real time and non-real-time images taken previously;
a motion data acquiring processor configured to acquire real-time motion data on a first object contained in the real-time images and non-real-time motion data on a second object contained in the non-real-time images;
a 3D model operating processor configured to operate a real-time 3D model by applying the real-time motion data to the real-time 3D model and operates a non-real-time 3D model by applying the non-real-time motion data to the non-real-time 3D model;
a start point setting processor configured to set a start point by finding a pose of the non-real-time 3D model that matches a pose of the real-time 3D model; and
a motion matching processor configured to match motions of the real-time 3D model and the non-real-time 3D model by operating the real-time 3D model and the non-real-time 3D model based on the start point.

11. A motion matching system of heterogeneous three-dimensional (3D) models, the system comprising:
a real-time image providing device configured to provide real-time images taken in real time;
a non-real-time image providing device configured to provide non-real-time images that have already been taken; and
a motion matching device configured to match motions of a real-time 3D model operating based on the real-time images and a non-real-time 3D model operating based on the non-real-time images, and expresses the matched motions in a virtual world,
the motion matching device including:
an image collecting processor configured to collect the real-time images and the non-real-time images;
a motion data acquiring processor configured to acquire real-time motion data on a first object contained in the real-time images and non-real-time motion data on a second object contained in the non-real-time images;
a 3D model operating processor configured to operate a real-time 3D model with the real-time motion data applied and operates a non-real-time 3D model with the non-real-time motion data applied;
a start point setting processor configured to set a start point by finding a pose of the non-real-time 3D model that matches a pose of the real-time 3D model; and
a motion matching processor configured to match motions of the real-time 3D model and the non-real-time 3D model by operating the real-time 3D model and the non-real-time 3D model based on the start point.
